(19) United States
(12) Patent Application Publication
(10) Pub. No.: US 2019/0069218 A1
(43) Pub. Date: Feb. 28, 2019

(54) Flexible Transmission of Combined System Information Blocks

(71) Applicant: Nokia Solutions and Networks Oy, Espoo (FI)

(72) Inventors: Cassio Barboza RIBEIRO, Espoo (FI); Timo Erkki Lunttila, Espoo (FI); Juha Heiskala, Helsinki (FI); Michal Cierny, Helsinki (FI); Klaus Hugl, Wien (AT)

(21) Appl. No.: 15/773,621

(22) PCT Filed: Nov. 4, 2016
(86) PCT No.: PCT/EP2016/076628

§ 371 Date: May 4, 2018

(30) Foreign Application Priority Data
Nov. 5, 2015 (EP) PCT/EP2015/075857

(51) Int. Cl. H04W 48/10

(52) U.S. Cl. CPC H04W 48/10

(57) ABSTRACT

A method including receiving information on a first channel on preconfigured channel elements in a transmission time interval of a wireless communication system, wherein the information on the first channel includes first system information and downlink control information related to a transmission of second system information on a second channel in the transmission time interval. The method may further include receiving the second system information based on the downlink control information.

### FIELD

The present invention relates to the field of wireless communications. More specifically, the present invention relates to methods, apparatus, systems and computer programs for transmission of system information.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimizing the 3GPP LTE radio access technologies.

Communication systems may be configured to use a mechanism for aggregating radio carriers to support wider transmission bandwidth. In LTE this mechanism is referred to as carrier aggregation (CA) and can, according to LTE Rel. 12 specifications, support a transmission bandwidth up to 100 MHz. A communication device with reception and/or transmission capabilities for CA can simultaneously receive and/or transmit on multiple component carriers (CCs) corresponding to multiple serving cells, for which the communication device has acquired/monitors system information needed for initiating connection establishment. When CA is configured, the communication device has only one radio resource control (RRC) connection with the network. At RRC connection establishment/reestablishment or handover, one serving cell provides the non-access stratum (NAS) mobility information, such as tracking area identity information. At RRC connection (re)establishment or handover, one serving cell provides the security input. This cell is referred to as the primary serving cell (PCell), and other cells are referred to as the secondary serving cells (SCells). Depending on capabilities of the communication device, SCells can be configured to form together with the PCell a set of serving cells under CA. In the downlink, the carrier corresponding to the PCell is the downlink primary component carrier (DL PCC), while in the uplink it is the uplink primary component carrier (UL PCC). A SCell needs to be configured by the network using RRC signaling before usage in order to provide necessary information, such as DL radio carrier frequency and physical cell identity (PCI) information, to the communication device. A SCell for which such necessary information has been provided to a communication device is referred to as configured cell for this communication device. The information available at the communication device after cell configuration is in particular sufficient for carrying out cell measurements. A configured SCell is in a deactivated state after cell configuration for energy saving. When a SCell is deactivated, the communication device does in particular not monitor/receive the physical dedicated control channel (PDCCH) or physical downlink shared channel (PDSCH) in the SCell. In other words the communication device cannot communicate in a SCell after cell configuration, and the SCell needs to be activated before data transmission from/the communication device can be initiated in the SCell. LTE provides for a mechanism for activation and deactivation of SCells via media access control (MAC) control elements to the communication device.

Communication systems may be configured to support simultaneous communication with two or more access nodes. In LTE this mechanism is referred to as dual connectivity (DC). More specifically, a communication device may be configured in LTE to communicate with a master eNB (MeNB) and a secondary eNB (SeNB). The MeNB may typically provide access to a macrocell, while the SeNB may provide on a different radio carrier access to a relatively small cell, such as a picocell. Only the MeNB maintains for the communication device in DC mode a connection via an S1-MME interface with the mobility management entity (MME), that is, only the MeNB is involved in mobility management procedures related to a communication device in DC mode. LTE supports two different user plane architectures for communication devices in DC mode. In the first architecture (split bearer) only the MeNB is connected via an S1-U interface to the serving gateway (S-GW) and the user plane data is transferred from the MeNB to the SeNB via an X2 interface. In the second architecture the SeNB is directly connected to the S-GW, and the MeNB is not involved in the transport of user plane data to the SeNB. DC in LTE reuses with respect to the radio interface concepts introduced for CA in LTE. A first group of cells, referred to as master cell group (MCG), can be provided for a communication device by the MeNB and may comprise one PCell and one or more SCells, and a second group of cells, referred to as seconday cell group (SCG), is provided by the SeNB and may comprise a primary SCell (PSCell) with functionality similar to the PCell in the MCG, for example with regard to uplink control signaling from the communication device. This second group of cells may further comprise one or more SCells.

Future networks, such as 5G, may progressively integrate data transmissions of different radio technologies in a communication between one or more access nodes and a communication device. Accordingly, communication devices may be able to operate simultaneously on more than one radio access technology, and carrier aggregation and dual connectivity may not be limited to the use of radio carriers of only one radio access technology. Rather, aggregation of radio carriers according to different radio access technologies and concurrent communication on such aggregated carriers may be supported. Small cells, such as picocells, may progressively be deployed in future radio access networks to match the increasing demand for system capacity due to the growing population of communication devices and data applications. Integration of radio access technologies and/or a high number of small cells may bring about that a communication device may detect more and more cells in future networks which are suitable candidates for connection establishment. Enhancements of carrier aggregation and dual connectivity mechanisms may be needed to make best use of these cells in future radio access networks. Such enhancements may allow for an aggregation of a high number of radio carriers at a communication device, for example up to 32 are currently specified in LTE Rel. 13, and in particular an integration of radio carriers operated on unlicensed spectrum.

Aggregation of radio carriers for communication to/from a communication device and simultaneous communication with two or more access nodes may in particular be used for operating cells on unlicensed spectrum. Wireless communication systems may be licensed to operate in particular spectrum bands. A technology, for example LTE, may operate, in addition to a licensed band, in an unlicensed band. LTE operation in the unlicensed spectrum may be based on the LTE Carrier Aggregation (CA) framework where one or more low power secondary cells (SCells) operate in the unlicensed spectrum and may be either downlink-only or contain both uplink (UL) and downlink (DL), and where the primary cell (PCell) operates in the licensed spectrum and can be either LTE Frequency Division Duplex (FDD) or LTE Time Division Duplex (TDD).

Two proposals for operating in unlicensed spectrum are LTE Licensed-Assisted Access (LAA) and LTE in Unlicensed Spectrum (LTE-U). LTE-LAA specified in 3GPP as part of Rel. 13 and LTE-U as defined by the LTE-U Forum may imply that a connection to a licensed band is maintained while using the unlicensed band. Moreover, the licensed and unlicensed bands may be operated together using, e.g., carrier aggregation or dual connectivity. For example, carrier aggregation between a primary cell (PCell) on a licensed band and one or more secondary cells (SCells) on unlicensed band may be applied, and uplink control information of the SCells is communicated in the PCell on licensed spectrum.

In an alternative proposal stand-alone operation using unlicensed carrier only may be used. In standalone operation at least some of the functions for access to cells on unlicensed spectrum and data transmission in these cells are performed without or with only minimum assistance or signaling support from license-based spectrum. Dual connectivity operation for unlicensed bands can be seen as an example of the scenario with minimum assistance or signaling from licensed-based spectrum.

Unlicensed band technologies may need to abide by certain rules, e.g. a clear channel assessment procedure, such as Listen-Before-Talk (LBT), in order to provide fair coexistence between LTE and other technologies such as Wi-Fi as well as between LTE operators. In some jurisdictions respective rules may be specified in regulations.

In LTE-LAA, before being permitted to transmit, a user or an access point (such as eNodeB) may, depending on rules or regulatory requirements, need to perform a Clear Channel Assessment (CCA) procedure, such a Listen-Before-Talk (LBT). The user or access node may, for example, monitor a given radio frequency, i.e. carrier, for a short period of time to ensure that the spectrum is not already occupied by some other transmission. The requirements for CCA procedures, such as LBT, vary depending on the geographic region: e.g. in the US such requirements do not exist, whereas in e.g. Europe and Japan the network elements operating on unlicensed bands need to comply with LBT requirements. Moreover, CCA procedures, such as LBT, may be needed in order to guarantee co-existence with other unlicensed band usage in order to enable e.g. fair co-existence with Wi-Fi also operating on the same spectrum and/or carriers. After a successful CCA procedure the user or access point is allowed to start transmission within a transmission opportunity. The maximum duration of the transmission opportunity may be preconfigured or may be signaled in the system, and may extend over a range of 4 to 13 milliseconds. The access node may be allowed to schedule downlink (DL) transmissions from the access node and uplink (UL) transmissions to the access node within a certain time window. An uplink transmission may not be subject to a CCA procedure, such as LBT, if the time between a DL transmission and a subsequent UL transmission is less than or equal to a predetermined value. Moreover, certain signaling rules, such as Short Control Signaling (SCS) rules defined for Europe by ETSI, may allow for the transmission of control or management information without LBT operation, if the duty cycle of the related signaling does not exceed a certain threshold, e.g. 5%, within a specified period of time, for example 50 ms. The aforementioned SCS rules, for example, can be used by compliant communication devices, referred to as operating in adaptive mode for respective SCS transmission of management and control frames without sensing the channel for the presence of other signals. The term “adaptive mode” is defined in ETSI as a mechanism by which equipment can adapt to its environment by identifying other transmissions present in a band, and addresses a general requirement for efficient operation of communications systems on unlicensed bands. Further, scheduled UL transmissions may in general be allowed without LBT, if the time between a DL transmission from an access node and a subsequent UL transmission is less than or equal to a predetermined value, and the access node has performed a clear channel assessment procedure, such as LBT, prior to the DL transmission. The total transmission time covering both DL transmission and subsequent UL transmission may be limited to a maximum burst or channel occupancy time. The maximum burst or occupancy time may be specified, for example, by a regulator.

Data transmission on an unlicensed band or/and subject to a clear channel assessment procedure cannot occur pursuant to a predetermined schedule in a communication system. Rather, communication devices and access nodes need to determine suitable time windows for uplink transmission and/or downlink transmission. A respective time window may comprise one or more transmission time intervals (TTI), such as subframes in LTE, and is in the following referred to as uplink transmission opportunity or downlink transmission opportunity. A TTI is the time period reserved in a scheduling algorithm for performing a data transmission of a dedicated data unit in the communication system. The determination of uplink transmission opportunities and/or downlink transmission opportunities may be based on parameters related to the communication system, such as a configured pattern governing the sequence of uplink and downlink transmissions in the system. The determination may further be based on rules or regulations specifying a minimum and/or maximum allowed length of uplink transmissions and/or downlink transmissions. The determination of uplink and downlink opportunities may in particular be based on the outcome of a clear channel assessment procedure, and communication devices or access nodes will only start data transmission on a frequency band after having assessed that the frequency band is clear, that is, not occupied by data transmissions from other communication devices or access nodes. Further rules or regulations may govern data transmissions in a communication between an access node and one or more communication devices. These rules may, for example, specify a maximum length of a time window in the communication covering at least one transmission in a first direction, for example in DL in a cellular system from an access node of a cell, and at least one subsequent transmission in the reverse direction, for example in UL from one or more communication devices in the cell. Such a time window comprising one or more DL and UL transmissions is in the following referred to as communication opportunity. DL transmissions may comprise scheduling information which may be transmitted on a DL control channel. The scheduling information may in particular be used for scheduling one or more UL data transmissions and/or one or more DL data transmissions within the current one or more future communication opportunities.

Scheduling information for a data transmission is indicative of an assignment of contents attributes, format attributes and mapping attributes to the data transmission. Mapping attributes relate to one or more channel elements allocated to the transmission on the physical layer. Specifics of the channel elements depend on the radio access technology and may depend on the used channel type. A channel element may relate to a group of resource elements, while each resource element relates to a frequency attribute, for example a subcarrier index (and the respective frequency range) in a system employing orthogonal frequency-division multiplexing (OFDM), and a time attribute, such as the transmission time of an OFDM or Single-Carrier FDMA symbol. A channel element may further relate to a code attribute, such as a cover code or a spreading code, which may allow for parallel data transmission on the same set of resource elements. Illustrative examples for channel elements in LTE are control channel elements (CCE) on the physical downlink control channel (PDCCH) or the enhanced physical downlink control channel (EPDCCH), PUCCH resources on the physical uplink control channel (PUCCH), and physical resource blocks (PRB) on the physical downlink shared channel (PDSCH) and the physical uplink shared channel (PUSCH). It should be understood that each data transmission is associated with the code attributes of the allocated channel elements and the frequency and time attributes of the resource elements in the allocated channel elements. Format attributes relate to the processing of a set of information bits in the transmission prior to the mapping to the allocated channel elements. Format attributes may in particular comprise a modulation and coding scheme used in the transmission and the length of the transport block in the transmission. Contents attributes relate to the user/payload information conveyed through the transmission. In other words, a contents attribute is any information which may in an application finally affect the arrangement of a detected data sequence at the receiving end. Contents attributes may comprise the sender and/or the receiver of the transmission. Contents attributes may further relate to the information bits processed in the transmission, for example some kind of sequence number in a communication. Contents attributes may in particular indicate whether the transmission is a retransmission or relates to a new set of information bits. In case of a hybrid automatic repeat request (HARQ) scheme contents attributes may in particular comprise an indication of the HARQ process number, that is, a HARQ-specific sequence number, the redundancy version (RV) used in the transmission and a new data indicator (NDI).

Scheduling information for a data transmission need not comprise assignment information for the complete set of attributes needed in the data transmission. At least a part of the attributes can be preconfigured, for example through semi-persistent scheduling, and can be used in more than one data transmission. Some of the attributes may be signaled implicitly or may be derivable, for example from timing information. However, dynamic scheduling in a more complex system, such as a cellular mobile network, requires transmission of scheduling information on a DL control channel. In a system employing carrier aggregation the DL scheduling information related to a certain data transmission may be transmitted on a component carrier other than the data transmission. Transmission of a data and scheduling information on different component carriers is referred to as cross-carrier scheduling.

Scheduling information may be included in downlink control information (DCI). There may be different message formats for transmitting downlink control information (DCI) depending on the number and the size of the contents, format and mapping attributes needed for configuring certain types of data transmissions. Downlink control information (DCI) may be transmitted on a downlink control channel, such as the physical downlink control channel (PDCCH) or the enhanced physical downlink control channel (EPDCCH) in LTE. Scheduling information may be destined to individual communication devices, groups of communication devices or all communication devices in a cell. The downlink control information may comprise respective identity information of the addressed communication devices. This identity information may be included in the encoding of the downlink control information for error detection, for example by including the identity information in a cyclic redundancy check (CRC) calculation. A device-specific identifier, such as the cell radio network temporary identifier (C-RNTI) in LTE, may be used for normal unicast data transmission to a certain communication device. Specific identifiers, such as the system information RNTI (SI-RNTI) and the paging RNTI (P-RNTI) may be configured for notifying communication devices in a cell of non-unicast data transmissions and data transmissions prior to the assignment of a device-specific identifier in a cell.

In a cell operated on unlicensed spectrum a communication device may start monitoring channel elements related to a DL control channel carrying scheduling information after detection of DL data burst in the cell. The detection of the DL data burst may be based on the detection of a certain signal in the cell, for example a reference signal, such as a cell reference signal which the communication device may blindly detect, or based on explicit signaling indicative of the presence of the DL data burst. Monitoring channel elements related to a DL control channel may comprise blind detection of scheduling information destined to the communication device. The control channel may be a physical downlink control channel (PDCCH) or enhanced physical downlink control channel (EPDCCH) as specified in LTE or a similar channel. The communication device may further detect a DL data transmission on a data channel, such as a physical downlink shared channel (PDSCH) or a similar channel, based on the detected scheduling information.

A communication system may employ a retransmission mechanism, such as Automatic Repeat Request (ARQ), for handling transmission errors. A receiver in such a system may use an error-detection code, such as a Cyclic Redundancy Check (CRC), to verify whether a data packet was received in error. The receiver may notify the transmitter on a feedback channel of the outcome of the verification by sending an acknowledgement (ACK) if the data packet was correctly received or a non-acknowledgement (NACK) if an error was detected. The transmitter may subsequently transmit a new data packet related to other information bits, in case of an ACK, or retransmit the data packet received in error, in case of a NACK. The retransmission mechanism may be combined with forward error-correction coding (FEC), in which redundancy information is included in the data packet prior to transmission. This redundancy information can be used at the receiver for correcting at least some of the transmission errors, and retransmission of a data packet is only requested in case of uncorrectable errors. Such a combination of FEC and ARQ is referred to as hybrid automatic repeat request (HARQ). In a HARQ scheme the receiver may not simply discard a data packet with uncorrectable errors, but may combine obtained information with information from one or more retransmissions related to the same information bits. These retransmissions may contain identical copies of the first transmission. In more advanced schemes, such as incremental redundancy (IR) HARQ, the first transmission and related retransmissions are not identical. Rather, the various transmissions related to the same information bits may comprise different redundancy versions (RV), and each retransmission makes additional redundancy information available at the receiver for data detection. The number of transmissions related to the same information bits may be limited in a communication system by a maximum number of not successful transmissions, and a data packet related to new information bits may be transmitted once the maximum number of not successful transmissions has been reached. A scheduling grant may comprise a new data indicator (NDI) notifying a communication device whether the scheduled transmission is destined for a data packet related to new information bits. Further or alternatively, the scheduling grant may comprise an indication of the redundancy version (RV) used or to be used in the transmission. Each data packet, often referred to as transport block, may be transmitted in a communication system within a transmission time interval (TTI), such as a subframe in LTE. At least two transport blocks may be transmitted in parallel in a TTI when spatial multiplexing is employed. Processing of a transport block, its transmission and the processing and transmission of the corresponding HARQ-ACK feedback may take several TTIs. For example, in LTE-FDD such a complete HARQ loop takes eight subframes. Accordingly, eight HARQ processes are needed in a data stream in LTE-FDD for continuous transmission between an access node and a communication device. The HARQ processes are handled in the access nodes and the communication devices in parallel, and each HARQ process controls the transmission of transport blocks and ACK/NACK feedback related to a set of information bits in the data stream.

For communicating in a wireless communication system a communication device needs to know basic configuration information of the system. This basic configuration information is in the following referred to as system information. System information may therefore be broadcast repeatedly from access points of a wireless communication system. The time period between two broadcasts of the same information element may depend on the relevance of the conveyed information for a communication device entering a cell. System information elements may therefore be grouped into system information blocks (SIB) in dependence on their relevance of the conveyed information. One system information block may provide an initial set of system information elements. This system information block is in the following referred to a as master information block (MIB). The master information block (MIB) may comprise parameters needed for initial access of a communication device to the system. The communication device may need to receive the master information block (MIB) before it can start reading/detecting further system information. The master information block (MIB) may therefore be transmitted on a dedicated broadcast channel, such as the physical broadcast channel (PBCH) in LTE.

This dedicated broadcast channel may be transmitted on predetermined or preconfigured channel/resource elements, so as to allow for detection of the master information block (MIB) by a communication device without having prior knowledge of essential system parameters, such as the system bandwidth. The PBCH in LTE, for example, is mapped in each radio frame (system frame) to the central 72 subcarriers of the first four OFDM symbols in the second slot of the first subframe. Accordingly, the PBCH is transmitted in LTE every 10 ms. The master information block on the PBCH is updated in LTE every 40 ms and each repetition within this update period contains an individually decodable version of the master information block (MIB).

Further system information related to other system information blocks (SIBs) may be transmitted on a shared downlink channel, such as the physical downlink shared channel (PDSCH) in LTE. Downlink control information (DCI) may notify communication devices in a cell of the presence of system information on the downlink shared channel. The downlink control information (DCI) may be transmitted on a downlink control channel, such as the physical downlink control channel (PDCCH) in LTE. The downlink control information (DCI) may be marked on the downlink control channel with a specific identifier, such as the system information radio network temporary identifier (SI-RNTI) in LTE.

As discussed above, system information elements may be grouped in dependence on the relevance of the information provided therein. An exemplary grouping is presented in the following with reference to some system information block types in LTE:
A first system information block type, such as SIB1 in LTE, may provide scheduling information on the transmission of further system information blocks (SIB2 and beyond in LTE). The first system information block type may include information on at least one operator of the cell. It may further comprise access restrictions with regard to different groups of communication devices. The first system information block type may further comprise information indicative of the allocation of transmission time intervals in uplink or downlink in a communication opportunity, such as the uplink-downlink configuration in LTE-TDD.
A second system information block type, such as SIB 2 in LTE, may include information on the uplink cell bandwidth. The second information block type may further include random access parameters and uplink power control parameters.
A third system information block type, such as SIB3 in LTE, may include information related to intra-frequency cell (re)selection.
Further system block types may include system information related to neighbouring cells, public warning messages, commercial alerting system information etc.

The various system information block types may be broadcast at regular time intervals. These time intervals may be configurable in a cell, and a respective schedule may be included in a special system information block type, such as SIB1 in LTE. The time period between two transmissions of said special system information block type may be preconfigured or may be specified in a standard. In LTE, for example, SIB1 is broadcast with an update period of 80 ms and repeated in the 5^{th} subframe of every radio frame with even system frame number (SFN).

However, for a system operated on unlicensed spectrum, it may not be possible to guarantee a deterministic set of transmission time intervals where essential system information elements can be found as such a system may need to apply a clear channel assessment procedure (CCA), such as Listen-Before-Talk (LBT), to coexist with other systems operating on the same band. Due to CCA/LBT, an access node may have to skip transmissions of the MIB or transmissions of some of the SIBs. This may lead to substantial delays in cell search procedures, and communication devices may not be able to access to a cell operated on unlicensed spectrum.

Another issue may be that an access node may not transmit signals on unlicensed spectrum, for example reference signals, when it is not transmitting data to a communication device in its cell, so as to allow for coexistence with other systems, such as Wi-Fi, or between operators using the same radio access technology, such as an LTE-based technology for operation on unlicensed spectrum. There may be exceptions to this requirement. For example, it may be possible to transmit Discovery Reference Signals (DRS), DRS may support small cell on/off operation where cells that are not activated for any communication device may be turned off except for periodic transmissions of DRS. DRS transmissions may occur in DRS occasions that may have a periodicity of, for example, 20, 40 or 80 ms. Downlink transmissions comprising DRS may further comprise a primary synchronisation signal (PSS), a secondary synchronisation signal (SSS), cell specific reference signals (CRS) and channel state information reference signals (CSI-RS), but may not include any data transmissions to communication devices.

A solution to the problem of reliable and fast detection of system information on unlicensed spectrum may be to allow for a transmission of system information in downlink transmissions comprising DRS. However, it may be desirable to avoid transmission of DRS at very short time intervals of, for example, 20 ms or even 10 ms as specified for the repetition period of the MIB in LTE. Therefore, it may be necessary to define a mechanism for combining system information blocks in certain transmission time interval, in order to avoid intolerable delays in cell search procedures. The transmission scheme for system information specified in LTE provides in principle a flexible mechanism for detection of basic system information, such as MIB, SIB1 and SIB2, in one transmission time interval. However, applying this mechanism would imply that a communication device would need to perform the following steps within only one transmission time interval:
1) Detect a downlink transmission of a cell from reference signals or synchronization signals, such as PSS and SSS and/or CRS
2) Decode a dedicated broadcast channel, such as the PBCH in LTE, to determine an initial set of system information elements, such as the MIB in LTE.
3) Decode an indicator channel, such as the physical control format indicator channel (PCFICH) in LTE to determine the position of a downlink control channel carrying scheduling information for further system information. The PCFICH in LTE, for example, comprises an indication of the number of PDCCH OFDM-symbols in a subframe.
4) Decode downlink control information on the downlink control channel to determine scheduling information related to the transmission of further system information blocks, such as SIB1 and SIB2 in LTE. This step may involves multiple blind decoding attempts.
5) Decode messages containing further system information blocks based on the decoded downlink control information.

This procedure comprises four extensive decoding steps in addition to the detection of the downlink transmission, so as to ensure a robust cell detection performance at a targeted SINR value in the range of −6 dB over the four decoding steps which have to pass one after the other for successful cell detection.

Another solution may be to transmit all the basic system information, such as MIB, SIB1 and SIB2 in LTE in a single new comprehensive SIB type. However, it would be very inefficient to define such a comprehensive SIB type, given the flexible contents and payload sizes of SIB1 and SIB2, and the requirement to support multiple system bandwidths. A code block for such a comprehensive SIB type would have a fixed size, but it would be much larger than the aggregated sizes of the individual code blocks for MIB, SIB1, and SIB2.

Therefore, there is a need to provide a flexible transmission scheme for combining system information in a communication system such that a communication device can determine the system information with acceptable decoding effort. There is in particular a need to provide such a scheme for a communication system employing a LTE-based radio access technology operated on unlicensed spectrum.

### SUMMARY

In a first aspect, there is provided a method comprising receiving information on a first channel on preconfigured channel elements in a transmission time interval of a wireless communication system, wherein the information on the first channel comprises first system information and downlink control information related to a transmission of second system information on a second channel in the transmission time interval, and receiving the second system information based on the downlink control information.

The method may comprise detecting one or more reference signals indicative of the transmission of the first channel in the transmission time interval.

The one or more reference signals may be transmitted at regular time intervals in a downlink transmission opportunity.

The first system information may comprise one or more of system bandwidth information and system frame number information, and the downlink control information may comprise at least one of:
allocation information indicative of channel elements allocated to the second channel, and
modulation and coding information indicative of a modulation and coding scheme used in the transmission of second system information.

The encoding for error detection may be commonly performed over the first system information and the downlink control information.

The first system information and the downlink control information may be encoded in one data packet.

The information on the first channel may remain unchanged for a predetermined number of repetitions.

The system frame number information in the first system information may not contain one or more of the least significant bits of the system frame number.

The second system information may comprises the one or more of the least significant bits of the system frame number.

The encoding for error detection may not include one or more of the least significant bits of the system frame number.

The number of the one or more of the least significant bits of the system frame number may depend on the predetermined number of repetitions.

The first system information may comprise at least one of:
information indicative of a public land mobile network identifier,
a network identifier
information related to a physical hybrid automatic repeat request indicator channel.

The downlink control information may comprise one or more of:
an indicator indicative of the type of information transmitted in the downlink control information,
an indication indicative of a localized or distributed allocation of the channel elements allocated to the second channel,
a new data indicator of a hybrid automatic repeat request scheme,
a process number of a hybrid automatic repeat request scheme,
a redundancy version of a hybrid automatic repeat request scheme,
a transmit power control command related to the transmission of uplink control information,
a gap value related to distributed allocation of the channel elements allocated to the second channel.

The encoding for error detection may comprise cyclic redundancy check bits.

The cyclic redundancy check bits may be scrambled according to the number of cell-specific reference signal ports.

The first channel may be a physical broadcast channel.

The second channel may be a physical downlink shared channel.

Only a subset of modulation and coding schemes available for data transmission on the second channel may be eligible for the modulation and coding information indicative of the modulation and coding scheme used in the transmission of the second system information.

Only a subset of channel elements available for data transmission on the second channel may be eligible for the allocation information indicative of channel elements allocated to the second channel.

The one or more reference signals may include at least one of:
a discovery reference signal,
a cell-specific reference signals,
a primary synchronization signal,
a secondary synchronization signal,
a channel state information reference signal.

The first channel may be an enhanced physical broadcast channel of an evolved universal terrestrial radio access network.

The second system information may comprise one or more information elements of system information block type 1 and/or one or more information elements of system information block type 2 of an evolved universal terrestrial radio access network.

In a second aspect, there is provided a method comprising causing transmission of information on a first channel on preconfigured channel elements in a transmission time interval of a wireless communication system, wherein the information on the first channel comprises first system information and downlink control information related to a transmission of second system information on a second channel in the transmission time interval, and causing transmission of the second system information according to the downlink control information.

The method may comprise transmission of one or more reference signals indicative of the transmission of the first channel in the transmission time interval.

The one or more reference signals may be transmitted at regular time intervals in a downlink transmission opportunity.

The first system information may comprise one or more of system bandwidth information and system frame number information, and the downlink control information may comprise at least one of:
allocation information indicative of channel elements allocated to the second channel, and
modulation and coding information indicative of a modulation and coding scheme used in the transmission of second system information.

The encoding for error detection may be commonly performed over the first system information and the downlink control information.

The first system information and the downlink control information may be encoded in one data packet.

The information on the first channel may remain unchanged for a predetermined number of repetitions.

The system frame number information in the first system information may not contain one or more of the least significant bits of the system frame number.

The second system information may comprises the one or more of the least significant bits of the system frame number.

The encoding for error detection may not include one or more of the least significant bits of the system frame number.

The number of the one or more of the least significant bits of the system frame number may depend on the predetermined number of repetitions.

The first system information may comprise at least one of:
information indicative of a public land mobile network identifier,
a network identifier
information related to a physical hybrid automatic repeat request indicator channel.

The downlink control information may comprise one or more of:
an indicator indicative of the type of information transmitted in the downlink control information,
an indication indicative of a localized or distributed allocation of the channel elements allocated to the second channel,
a new data indicator of a hybrid automatic repeat request scheme,
a process number of a hybrid automatic repeat request scheme,
a redundancy version of a hybrid automatic repeat request scheme,
a transmit power control command related to the transmission of uplink control information,
a gap value related to distributed allocation of the channel elements allocated to the second channel.

The encoding for error detection may comprise cyclic redundancy check bits.

The cyclic redundancy check bits may be scrambled according to the number of cell-specific reference signal ports.

The first channel may be a physical broadcast channel.

The second channel may be a physical downlink shared channel.

Only a subset of modulation and coding schemes available for data transmission on the second channel may be eligible for the modulation and coding information indicative of the modulation and coding scheme used in the transmission of the second system information.

Only a subset of channel elements available for data transmission on the second channel may be eligible for the allocation information indicative of channel elements allocated to the second channel.

The one or more reference signals may include at least one of:
a discovery reference signal,
a cell-specific reference signals,
a primary synchronization signal,
a secondary synchronization signal,
a channel state information reference signal.

The first channel may be an enhanced physical broadcast channel of an evolved universal terrestrial radio access network.

The second system information may comprise one or more information elements of system information block type 1 and/or one or more information elements of system information block type 2 of an evolved universal terrestrial radio access network.

In a third aspect, there is provided an apparatus, said apparatus comprising at least one processor; and at least one memory including computer program code, the at least one memory and the computer program code configured, with the at least one processor, to cause the apparatus at least to receive information on a first channel on preconfigured channel elements in a transmission time interval of a wireless communication system, wherein the information on the first channel comprises first system information and downlink control information related to a transmission of second system information on a second channel in the transmission time interval, and receive the second system information based on the downlink control information.

In a forth aspect, there is provided an apparatus, said apparatus comprising at least one processor; and at least one memory including computer program code, the at least one memory and the computer program code configured, with the at least one processor, to cause the apparatus at least to cause transmission of information on a first channel on preconfigured channel elements in a transmission time interval of a wireless communication system, wherein the information on the first channel comprises first system information and downlink control information related to a transmission of second system information on a second channel in the transmission time interval, and cause transmission of the second system information according to the downlink control information.

In a fifth aspect, there is provided an apparatus comprising means for performing a method according to embodiments of the first aspect.

In a sixth aspect, there is provided an apparatus comprising means for performing a method according to embodiments of the second aspect.

In a seventh aspect, there is provided a computer program embodied on a non-transitory computer-readable storage medium, the computer program comprising program code for controlling a process to execute a process, the process comprising receiving information on a first channel on preconfigured channel elements in a transmission time interval of a wireless communication system, wherein the information on the first channel comprises first system information and downlink control information related to a transmission of second system information on a second channel in the transmission time interval, and receiving the second system information based on the downlink control information.

In an eighth aspect, there is provided a computer program embodied on a non-transitory computer-readable storage medium, the computer program comprising program code for controlling a process to execute a process, the process comprising causing transmission of information on a first channel on preconfigured channel elements in a transmission time interval of a wireless communication system, wherein the information on the first channel comprises first system information and downlink control information related to a transmission of second system information on a second channel in the transmission time interval, and causing transmission of the second system information according to the downlink control information.

In a ninth aspect, there is provided a computer program product for a computer, comprising software code portions for performing the steps of a method according to embodiments of the first aspect.

In a tenth aspect, there is provided a computer program product for a computer, comprising software code portions for performing the steps of a method according to embodiments of the second aspect.

In an eleventh aspect, there is provided a mobile communication system comprising at least one apparatus according to the third aspect and at least one apparatus according to the forth aspect.

In a twelfth aspect, there is provided a mobile communication system comprising at least one apparatus according to the fifth aspect and at least one apparatus according to the sixth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows an example method of a mobile communication device for combined transmission of basic system information in a transmission time interval;

FIG. 4 shows an example method of an access node for combined transmission of basic system information in a transmission time interval;

FIG. 5 shows a schematic diagram of an example control apparatus;

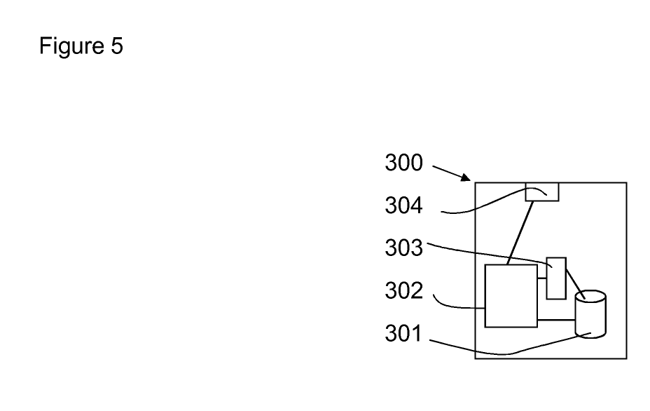

### DETAILED DESCRIPTION

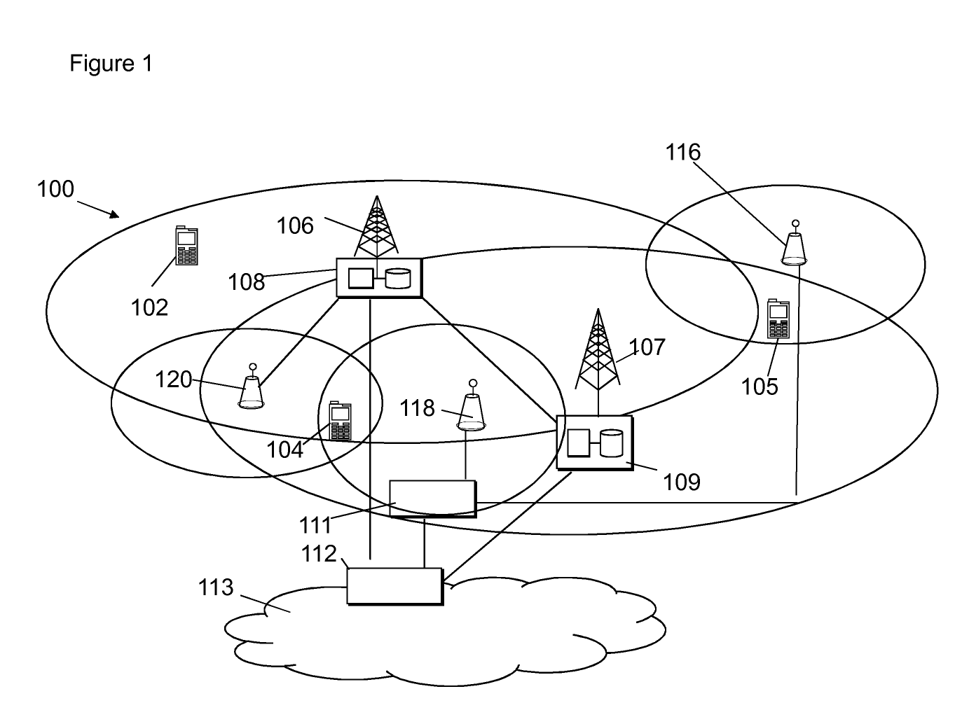

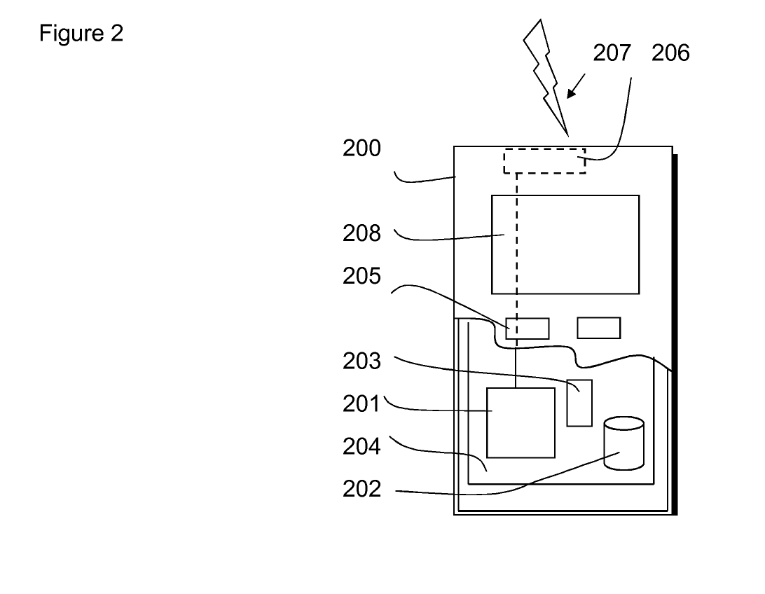

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signaling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

As discussed above, there is a need to provide a flexible transmission scheme for combining system information in a communication system such that a communication device can determine the system information with acceptable decoding effort. The scheme may in particular be used in communication systems employing a LTE-based radio access technology operated on unlicensed spectrum. In such a scheme an initial set of system information, similar to the MIB in LTE, may be combined in one data block with downlink control information related to the transmission of further basic system information, similar to the system information provided in SIB1 and SIB2 in LTE. This data block may have a preconfigured or fixed size and the respective information may be broadcast from an access node on preconfigured or predetermined channel elements.

The beneficial effect of such a transmission scheme may be seen in that it comprises only two decoding steps and avoids the specification of a comprehensive system information block of preconfigured or fixed size. The transmission of downlink control information on a preconfigured or predetermined channel elements avoids in particular the decoding effort for determining the position of the downlink control channel carrying scheduling information for further system information, and it avoids blind decoding efforts of the downlink control information on the downlink control channel based on a specific identifier, such as the SI-RNTI in LTE.

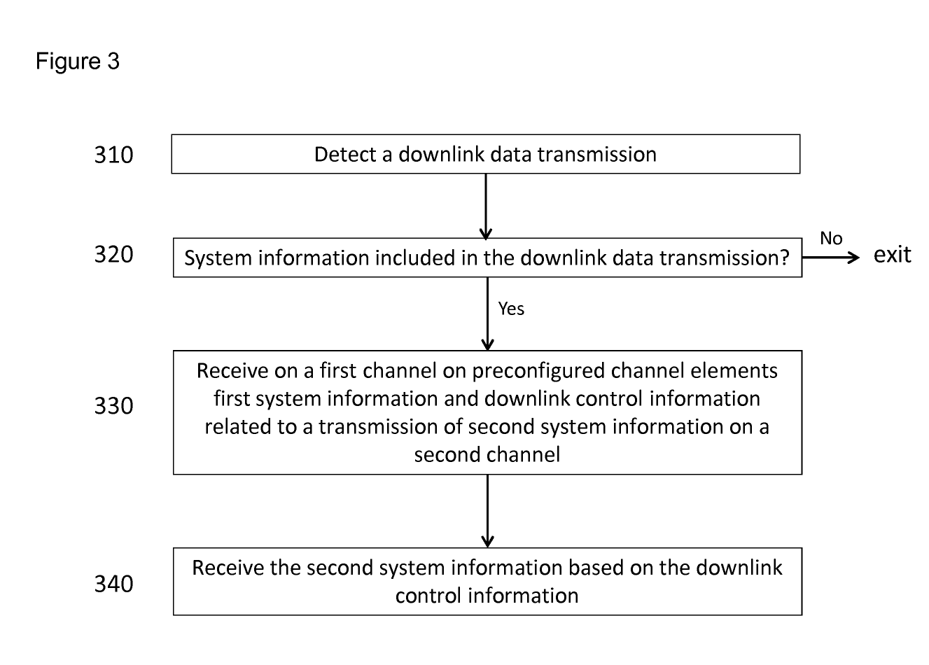

FIG. 3 shows an example method of a mobile communication device for combined transmission of basic system information in a transmission time interval.

At step 310, the communication device detects a downlink data transmission in a cell of a communication system. The detection may be based on received synchronization signals, such as PSS and SSS in LTE, and/or based on received reference signals similar to the CRS in LTE. The method proceeds to step 320.

At step 320, the communication device may determine whether the downlink data transmission includes system information. The communication device may try to detect a specific reference signal, for example a discovery reference signal, in order to determine whether the downlink data transmission includes system information. Alternatively or in addition, the communication device may use information on the time interval between two transmissions of the specific reference signal. The method proceeds to step 330 if the communication device determines that the downlink data transmission includes system information. Otherwise, the method exits. Step 320 provides a check mechanism so as to avoid unnecessary processing of the following steps 330 and 340. However, this step may be omitted and the method may proceed in an alternative embodiment directly from step 310 to step 330.

At step 330, the communication device may receive on a first channel on preconfigured or predetermined channel elements first system information and downlink control information related to a transmission of second system information on a second channel. The first channel may be a broadcast channel, similar to the PBCH in LTE, and is in the following referred to as enhanced physical broadcast channel (ePBCH). The second channel may be a downlink shared channel, similar to the PDSCH in LTE. The communication device may process the ePBCH based on preconfigured or predetermined format attributes, such as a transport block size and a modulation and coding scheme. The information carried on the ePBCH may comprise information similar to the master information block (MIB) in LTE. It may, for example, comprise parameters needed for initial access of a communication device to the communication system. The information may in particular comprise all information the communication device needs for processing the received downlink control information related to the transmission of the second system information. The downlink control information may comprise format attributes and mapping attributes related to the transmission of one or more system information blocks on a downlink shared channel, such as the PDSCH in LTE. In case of successful decoding of the information provided on the ePBCH, the method proceeds to step 340.

At step 340, the communication device may receive the second system information based on the downlink control information provided on the ePBCH.

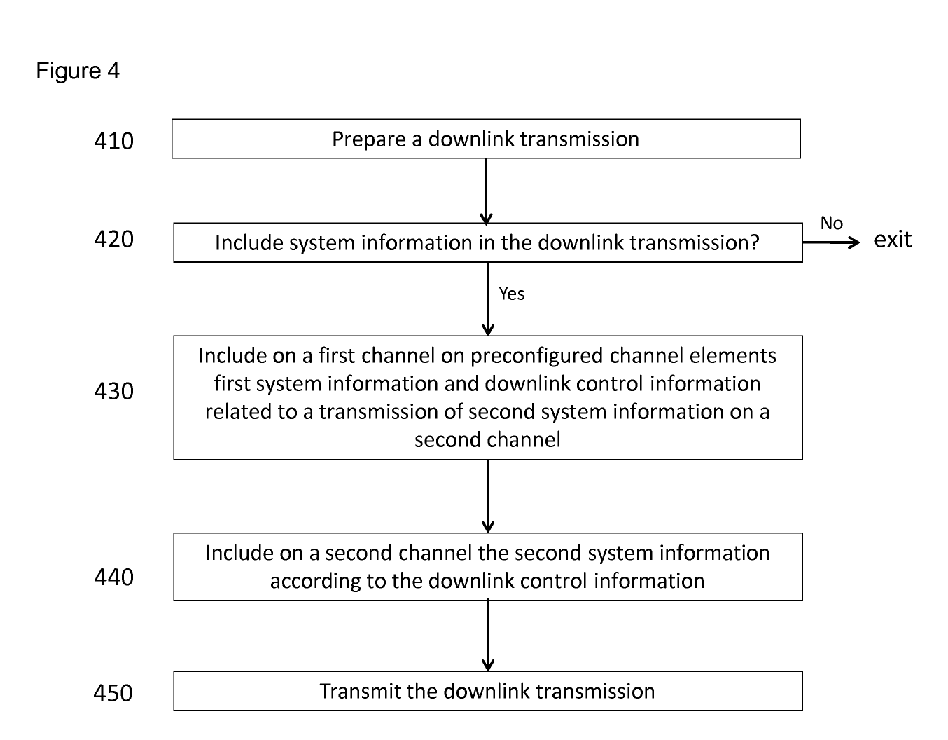

FIG. 4 shows an example method of an access node for combined transmission of basic system information in a transmission time interval.

At step 410, the access node prepares a downlink transmission in a transmission time interval of a communication system. The downlink transmission may comprise synchronization signals, such as PSS and SSS in LTE, and/or reference signals similar to the CRS in LTE, which may be used by communication devices in a cell for detecting the downlink transmission. The method proceeds to step 420.

At step 420, the access node may determine whether the downlink transmission includes system information. The access node may include a specific reference signal, for example a discovery reference signal, if system information is to be included in the downlink transmission. The method proceeds to step 430 if the access nodes determines that the downlink transmission includes system information. Otherwise, the method exits.

At step 430, the access node may include on a first channel on preconfigured or predetermined channel elements first system information and downlink control information related to a transmission of second system information on a second channel. The first channel may be a broadcast channel, similar to the PBCH in LTE, and is in the following referred to as enhanced physical broadcast channel (ePBCH). The second channel may be a downlink shared channel, similar to the PDSCH in LTE. The access node may transmit the ePBCH based on preconfigured or predetermined format attributes, such as a transport block size and a modulation and coding scheme. The information carried on the ePBCH may comprise information similar to the master information block (MIB) in LTE. It may, for example, comprise parameters needed for initial access of a communication device to the communication system. The information may in particular comprise all information a communication device needs for processing the included downlink control information related to the transmission of the second system information The downlink control information may comprise format attributes and mapping attributes related to the transmission of one or more system information blocks on a downlink shared channel, such as the PDSCH in LTE. The method proceeds to step 440.

At step 440, the access node may include on a second channel the second system information according to the downlink control information included on the ePBCH. The method proceeds to step 450.

At step 450, the access node transmits the downlink transmission including first system information on the first channel and second system information on the second channel according to the downlink control information provided on ePBCH.

In embodiments the ePBCH content may be specified as a combination of system information elements, similar to the MIB in LTE and downlink control information similar to the information provided in DCI formats 1A or 1C in LTE:
The first system information may comprise in some embodiments:
   a system bandwidth—3 bits
   PHICH information—3 bits
   a system frame number—8 bits
   a field reserved for future use—10 bits
The downlink control information may in some embodiments be based on DCI format 1A in LTE and may comprise:
   a flag for format0/format1A differentiation—1 bit, that is an indicator indicative of the type of information transmitted in the downlink control information.
   localized/distributed VRB flag—1 bit, that is, an indication indicative of a localized or distributed allocation of the channel elements allocated to the second channel
   new data indicator—1 bit, that is, a new data indicator of a hybrid automatic repeat request scheme.
   resource bocks assigned—(for example 11-13 bits, assuming a minimum bandwidth of 10 MHz), that is, allocation information indicative of channel elements allocated to the second channel
   a modulation and coding scheme—5 bits
   a process number of a hybrid automatic repeat request scheme—3-4 bits
   a redundancy version of a hybrid automatic repeat request scheme—2 bits
   TPC for PUCCH—2 bits, that is, a transmit power control command related to the transmission of uplink control information
The downlink control information may in some embodiments be based on DCI format 1C in LTE and may comprise:
   N_Gap—1 bit, that is, a gap value related to distributed allocation of the channel elements allocated to the second channel
   RB assignment—6-9 bits, that is, allocation information indicative of channel elements allocated to the second channel
   a modulation and coding scheme—5 bits

Using DCI format 1C as baseline for scheduling of system information via ePBCH may allow for a maximum size of the second system information of 1736 bits in a LTE-based radio access technology. Using DCI format 1A as baseline for scheduling of system information via ePBCH may allow for a maximum size of the second system information of 2260 bits in a LTE-based radio access technology.

However, fields in both the first system information and the downlink control information may be removed or reduced in size in some embodiments, for example, fields related to the PHICH configuration may be removed (assuming that PHICH will not be used in LTE-based radio access technologies operated on unlicensed spectrum). In other embodiments fields related to HARQ operation may be removed, assuming that HARQ is not used for transmission of system information.

In an embodiment the ePBCH may only comprise:
a system bandwidth
a system frame number
RB assignment for SIB, that is, allocation information indicative of channel elements allocated to the second channel
MCS for SIB, that is, a modulation and coding scheme for the second system information.

Some bits may be reserved in ePBCH for further enhancements. In some embodiments, the ePBCH may include the two least significant bits of the system frame number in an LTE-based radio access technology if operated on unlicensed spectrum, as it may then not be possible to derive the two least significant bits of the system frame number implicitly, in contrast to a conventional LTE system.

The number of system bandwidth options may be smaller than in conventional LTE. The targeted bandwidth options in the bands of interest may be 10 MHz or 20 MHz.

The field related to resource allocation/mapping attributes, may be reduced to about 20 bits. This may lead to approximately 24+20=44 information bits carried on ePBCH. The ePBCH processing may further include 16 CRC bits, as currently specified for PBCH in LTE. The total size of the data block carried on ePBCH may therefore be in the range of about 60 bits, which means only an increase of about 50% compared to the PBCH in a conventional LTE system.

In some embodiments the size of the data block carried on ePBCH may further be reduced by restricting the number of available modulation and coding schemes for the second system information. In other words, only a subset of modulation and coding schemes available for data transmission on the second channel may be eligible for the modulation and coding information indicative of the modulation and coding scheme used in the transmission of the second system information. A subset of the available modulation and coding schemes may be sufficient because only robust modulation and coding schemes may ensure the required reliable transmission of second system information.

In some embodiments the size of the data block carried on ePBCH may further be reduced by restricting the flexibility with regard to the allocation of resources on the second channel for the transmission of the second system information. In other words, only a subset of channel elements available for data transmission on the second channel may be eligible for allocation information indicative of channel elements allocated to the second channel. Restricting the allocation flexibility for the second system information may be possible, since transmission of system information may not be based on channel-aware scheduling, for example based on CSI feedback from the communication devices.

The data block carried on ePBCH may include additional information available for fast decoding, for example information indicative of a public land mobile network identifier (PLMN ID), for example, a part of the PLMN ID.

An encoding for error detection may be commonly performed over the first system information and the downlink control information, for example one CRC may be calculated of both parts of the data block carried on ePBCH. In some embodiments the first system information and the downlink control information may be commonly encoded in one data packet.

The target system bandwidth of systems operated on unlicensed spectrum may be at least 10 MHz. Therefore it may not be necessary to constrain the channel elements allocated to ePBCH to the central 72 subcarriers (or 6 central physical resource blocks) in an LTE-based system if operated on unlicensed spectrum. The channel elements for ePBCH may be preconfigured or predetermined such, that testing of location hypotheses for detecting the ePBCH is avoided or at least limited.

An update period may be specified for ePBCH which may include several repetitions, as to ensure a reliable decoding of the data block carried on ePBCH. For example, the data block carried on ePBCH may in some embodiments be changed only in every n^{th} transmission opportunity. This facilitates averaging/combining of ePBCH samples at the communication devices, for example for coverage extension of a cell.

In case of such repetitions, the contents of the data block carried on ePBCH may remain constant within a preconfigured or predetermined update period known to the communication devices. This implies that the first system information broadcast on ePBCCH may not contain the latest system frame number.

In some embodiments the least significant bits of the system frame number may therefore be added only in the second system information carried on the second channel. The scrambling of the SIB messages in the second system information may therefore take into account that a communication device may not know the complete system frame number when it starts processing the second system information. The downlink control information carried on ePBCH, for example resource allocation and modulation and coding scheme, may only be changed at the boundaries of the update periods.

In other embodiments the least significant bits of the system frame number may not be included in the encoding for error detection. The first system information may in these embodiments comprise a static part which remains unchanged within an update period, and which can be decoded by communication devices independent from a dynamic part comprising the least significant bits of the system frame number.

It should be understood that each block of the flowchart of the Figures and any combination thereof may be implemented by various means or their combinations, such as hardware, software, firmware, one or more processors and/or circuitry.

The method may be implemented on a mobile device as described with respect to FIG. 2 or control apparatus as shown in FIG. 7. FIG. 7 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise providing combined system information in certain transmission time intervals.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE networks, similar principles may be applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving information on a first channel on preconfigured channel elements in a transmission time interval of a wireless communication system, wherein the information on the first channel comprises first system information and downlink control information related to a transmission of second system information on a second channel in the transmission time interval; and
receiving the second system information based on the downlink control information.

2. A method according to claim 1, comprising detecting one or more reference signals indicative of the transmission of the first channel in the transmission time interval.

3. A method according to claim 2, wherein the one or more reference signals are transmitted at regular time intervals in a downlink transmission opportunity.

4. A method according to claim 1, wherein the first system information comprises one or more of system bandwidth information and system frame number information, and the downlink control information comprises at least one of:
allocation information indicative of channel elements allocated to the second channel, and
modulation and coding information indicative of a modulation and coding scheme used in the transmission of second system information.

5. A method according to claim 1, wherein encoding for error detection is commonly performed over the first system information and the downlink control information.

6. A method according to claim 1, wherein the first system information and the downlink control information are encoded in one data packet.

7. A method according to claim 1, wherein the information on the first channel remains unchanged for a predetermined number of repetitions.

8. A method according to claim 7,
wherein the first system information comprises one or more of system bandwidth information and system frame number information, and the downlink control information comprises at least one of:
allocation information indicative of channel elements allocated to the second channel, and
modulation and coding information indicative of a modulation and coding scheme used in the transmission of second system information; and
wherein the system frame number information in the first system information does not contain one or more of the least significant bits of the system frame number.

9.-22. (canceled)

23. A method comprising:
causing transmission of information on a first channel on preconfigured channel elements in a transmission time interval of a wireless communication system, wherein the information on the first channel comprises first system information and downlink control information related to a transmission of second system information on a second channel in the transmission time interval; and
causing transmission of the second system information according to the downlink control information.

24. A method according to claim 23, comprising transmission one or more reference signals indicative of the transmission of the first channel in the transmission time interval.

25. A method according to claim 24, wherein the one or more reference signals are transmitted at regular time intervals in a downlink transmission opportunity.

26. A method according to claim 23, wherein the first system information comprises one or more of system bandwidth information and system frame number information, and the downlink control information comprises at least one of:
allocation information indicative of channel elements allocated to the second channel, and
modulation and coding information indicative of a modulation and coding scheme used in the transmission of second system information.

27. A method according to claim 23, wherein encoding for error detection is commonly performed over the first system information and the downlink control information.

28. A method according to claim 23, wherein the first system information and the downlink control information are encoded in one data packet.

29. A method according to claim 23, wherein the information on the first channel remains unchanged for a predetermined number of repetitions.

30. A method according to claim 29:
wherein the first system information comprises one or more of system bandwidth information and system frame number information, and the downlink control information comprises at least one of:
allocation information indicative of channel elements allocated to the second channel, and
modulation and coding information indicative of a modulation and coding scheme used in the transmission of second system information; and
wherein the system frame number information in the first system information does not contain one or more of the least significant bits of the system frame number.

31.-44. (canceled)

45. An apparatus comprising:
at least one processor; and
at least one memory including computer program code, the at least one memory and the computer program code configured, with the at least one processor, to cause the apparatus to perform at least the following:
receive information on a first channel on preconfigured channel elements in a transmission time interval of a wireless communication system, wherein the information on the first channel comprises first system information and downlink control information related to a transmission of second system information on a second channel in the transmission time interval; and
receive the second system information based on the downlink control information.

46. An apparatus comprising:
at least one processor; and
at least one memory including computer program code, the at least one memory and the computer program code configured, with the at least one processor, to cause the apparatus to perform at least the following:
cause transmission of information on a first channel on preconfigured channel elements in a transmission time interval of a wireless communication system, wherein the information on the first channel comprises first system information and downlink control information related to a transmission of second system information on a second channel in the transmission time interval; and
cause transmission of the second system information according to the downlink control information.

47.-48. (canceled)

49. A computer program product comprising a computer-readable medium, comprising software code portions for causing a computer to perform the steps of claim 1 when said product is run on the computer.

50. (canceled)
